(19) United States
(12) Patent Application Publication
(10) Pub. No.: US 2024/0302039 A1
(43) Pub. Date: Sep. 12, 2024

(54) SYSTEM AND METHOD FOR REDUCING POLLUTION FROM A COMBUSTION CHAMBER

(71) Applicant: GAVRIEL CLEAN TECH LTD, Hod-Hasaron (IL)

(72) Inventors: Amir NAFTALI, Tivon (IL); Avi HAREL, Hod-HaSaron (IL); Yanir DESHEL, Porya Kfar Avoda (IL); Yuval GONEN, Tivon (IL); Avrahm Rami LORE, Kiryat-Tivon (IL)

(73) Assignees: Avi Harel, Hod-Hasaron (IL); GAVRIEL CLEAN TECH LTD, Hod-Hasaron (IL)

(21) Appl. No.: 18/595,789

(22) Filed: Mar. 5, 2024

Related U.S. Application Data
(60) Provisional application No. 63/451,203, filed on Mar. 9, 2023.

(51) Int. Cl. F23J 15/02; B01D 45/14; B01D 47/06; B01D 50/40; F23J 15/04

(52) U.S. Cl. CPC F23J 15/027; B01D 45/14; B01D 47/06; B01D 50/40; F23J 15/04; F23J 2217/40; F23J 2217/50

(57) ABSTRACT

A new Emission-Cleaning-System (ECS) for reducing air pollution coming via a chimney is disclosed. The new ECS may comprise a cyclone-separator-with-liquid-injectors (CSWLI) that is associated with a chimney, wherein the path via the chimney remains undisturbed, a blower that is configured to pull smoke coming via the chimney toward the CSWLI. In addition the new ECS is controlled by an ECS Controlling Circuitry (ECC). The ECC is associated with one or more sensors and one or more accessories.

### CROSS REFERENCE TO RELATED PATENTS AND PATENT APPLICATIONS

This utility patent application being filed in the United States as a non-provisional application for patent under Title 35 U.S.C. § 100 et seq. and 37 C.F.R. § 1.53(b) and, claiming the benefit of the prior filing date under Title 35, U.S.C. § 119(e) of the United States provisional application for patent that was filed on Mar. 9, 2023 and assigned the Ser. No. 63/451,203, which application is herein incorporated by reference in its entirety. Further, this application is related to the following U.S. Pat. Nos. 7,056,366; 8,524,180; 7,780,932; and US publication US 2010-0,139,492, which are incorporated herein by reference in their entirety. Furthermore, this application is related to GB 2,076,335 which is incorporated herein by reference in its entirety.

### FIELD OF THE DISCLOSURE

The present disclosure relates to the field of smoke filtration. More specifically, the present disclosure refers to reducing air pollution from fume coming from wood burning fireplace or any other combustion chamber.

### BACKGROUND

According to research data from the American EPA, over 100 million wood stoves and water heating systems that use wood heating are active in the world. Emission from a common residential fireplace comprises particles that are associated with smell and pollute the air we breathe. The smoke may comprise particles of organic compounds, carbon monoxide, volatile organic compounds, and nitrous oxides. In this disclosure and the claims the words “wood burning fireplace”, fireplace, a grill of a restaurant, a “combustion chamber”, or any source of fume or gas may be used interchangeably. The term “wood burning fireplace” (WBF) may be used as a representative term for any source of fume that is associated with a chimney or stack. In this disclosure and the claims the words smoke, fume, particles, or gas may be used interchangeably and the term smoke can be used as representative term for this group. In this disclosure and the claims the words chimney or stack or exhaust may be used interchangeably.

A common fireplace pollutant removal device includes a filter, a fan, and a smoke detector. In operation, the filter is placed in the chimney, and the fan is positioned above the filter to draw the exhaust gases up via the filter. The smoke detector is mounted between the filter and the fire place. The smoke detector can be used in order to turn on the fan. Usually, a common filter is blocked after few months of operation. The block filter may disperse the smoke in the room, which poses a major health risk and potentially a life risk.

Another conventional fireplace pollutant filter utilizes a ceramic fiber duct positioned along the path of the flow of fire products, between the fire chamber and the chimney. Here, a first tube portion promotes secondary fire of unburned products of fire and a second duct portion directs products of fire from the front of the fire chamber to the chimney. Though some pollutants may be removed by this device by the secondary fire, many may still enter the atmosphere due to an incomplete removal by the secondary fire and the careless of pollutant removal from the combustion products flowing through the second pipe.

Another disadvantage of using one or more filters in between the fireplace and the chimney is the backpressure that is generated between the filter and the fireplace. This backpressure can be too high and prevent proper fireplace operation. The backpressure may increase when the filter is blocked.

### BRIEF SUMMARY

The needs and the deficiencies that are described above are not intended to limit the scope of the inventive concepts of the present disclosure in any manner. The needs are presented for illustration only. The disclosure is directed to a novel system and method for reducing air pollutants from wood burning fireplace.

The following presents a simplified summary of the disclosure in order to provide a basic understanding of certain disclosed embodiments. This summary is not an extensive overview of all expected embodiments, and is intended neither to identify key or critical elements, nor to delineate the scope of such embodiments. The sole purpose of the summary is to present some example embodiments in a simplified form as a prelude to a more detailed description, presented later.

Example embodiments of the disclosed technique may comprise a blower that is configured to pull smoke coming via a chimney from a fireplace toward a cyclone-separator-with-liquid-injectors (CSWLI). Thus, the path via the chimney remains undisturbed to avoid backpressure. The operation of CSWLI is disclosed in GB 2,076,335; U.S. Pat. Nos. 7,780,932; 8,524,180-B2; and US20100139492A1. A reader who wishes to learn more about the operation of a CSWLI is invited to read those documents.

An example embodiment of the disclosed technique may comprise a CSWLI that is associated with a tank that includes liquid. The liquid can be water, a combination of water and odor-liquid (OdL), etc. The OdL may provide odor to the process of cleaning the smoke coming from the fireplace. The odor can be a neutral odor such as odor of a lemon, for example.

The tank can be associated with few pipes and a pump. A first pipe may deliver clean water via an electric tap. The opening of this pipe can be placed deep in the tank. A second pipe, which it's opening is placed above the opening of the first pipe is used to drain surplus of the liquid out of the tank toward the sewage or to a treatment facility/system.

The 3^{rd} pipe is associated with the pump, which is used to pull liquid from the bottom of the tank and push it up toward the entry of the smoke from the chimney. The liquid that is pushed up is injected into the smoke and air coming from the fireplace to generate a spray of drops of mixture of liquid and smoke/air as an input to the CSWLI. The processed-air at the outlet of the CSWLI is pulled up by a blower via a drops-capture module. The drops-capture-module removes drops of the liquid that remained in the processed-air and clean air is exhausted out to the environment. A 4th pipe that is used to return the liquid after being used in the CSWLI.

Some example embodiments of the disclosed technique may have a float in order to control the level of the liquid in the tank. Some embodiments may use an optical sensor for the detecting the cleanness of the liquid in the tank and accordingly controls the operation of the electric tap. Yet, some embodiments may have temperature sensor for measuring the temperature of the liquid and accordingly may activate the electric tap. Thus, most of the time the liquid is circulated in the system without adding new liquid. New liquid is added only in certain cases as mentioned above.

Some embodiment of the disclosed technique may comprise a “T” type pipe which is associated with the chimney in a location along the chimney. The smoke coming from the fireplace via the chimney may enter to a 1^{st} pipe of the “T” and may pass without any disturbance via a 2^{nd} pipe of the “T” toward the opening of the chimney. The 3rd pipe of the “T” is associated with the inlet of the CSWLI. Thus, when the CSWLI is not working the smoke moves upward undisturbed via the chimney and when the CSWLI is operating it pull the smoke toward the CSWLI inlet.

An example embodiment of the disclosed technique may use a processing unit that controls the operation of the entire system. The processing unit can be configured to control the operation of the blower, the electric tap, the opening of the swirling means that generate the cyclone. In order to control the operation of the system the processing unit may obtain feedback from the one or more sensors. Sensors such as but not limited to temperature sensors, flow sensors and float that sense the volume of the liquid in the tank or an ultrasonic sensor that measure the distance between the sensor and the surface of the liquid in the tank.

The foregoing summary is not intended to summarize each potential embodiment or every aspect of the present invention, and other features and advantages of the present invention will become apparent upon reading the following detailed description of the embodiments with the accompanying drawings and appended claims.

Furthermore, although specific embodiments are described in detail to illustrate the inventive concepts to a person skilled in the art, such embodiments can be modified to various modifications and alternative forms. Accordingly, the figures and written description are not intended to limit the scope of the inventive concepts in any manner.

Other objects, features, and advantages of the present invention will become apparent upon reading the following detailed description of the embodiments with the accompanying drawings and appended claims.

### BRIEF DESCRIPTION OF THE DRAWINGS

Examples of embodiments of the present disclosure will be understood and appreciated more fully from the following detailed description, taken in conjunction with the drawings in which:

FIG. 1 shows a schematic presentation of relevant elements of an example installation of Emission-Cleaning-System (ECS) according to the present disclosure;

FIG. 2 shows a schematic presentation of relevant elements of an example of a drops-capture module according to the present disclosure;

FIG. 3 illustrates a simplified block diagram with relevant elements of an example of a ECS-Controlling-Circuitry (ECC) that operates according to the disclosed technique; and

FIG. 4 schematically illustrates a flowchart showing relevant processes that can be implemented by an example of a ECC in order to reduce of air pollutants from wood burning fireplace emissions.

### DESCRIPTION OF EMBODIMENTS

Turning now to the figures in which like numerals represent like elements throughout the several views, of embodiments of the present disclosure that are described. For convenience, only some elements of the same group may be labeled with numerals.

The purpose of the drawings is to describe examples of embodiments and not for production purpose. Therefore, features shown in the figures are chosen for convenience and clarity of presentation only and are not necessarily shown to scale. Moreover, the language used in this disclosure has been principally selected for readability and instructional purposes, and may not have been selected to define or limit the inventive subject matter.

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. Moreover, the language used in this disclosure has been principally selected for readability and instructional purposes, and may not have been selected to delineate or circumscribe the inventive subject matter, resort to the claims being necessary to determine such inventive subject matter.

Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

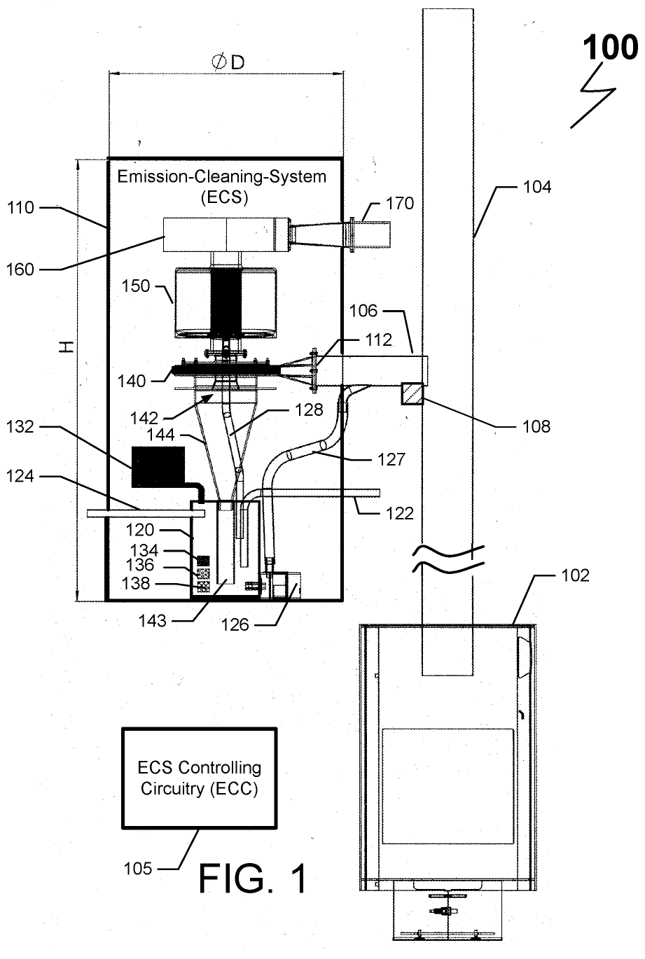

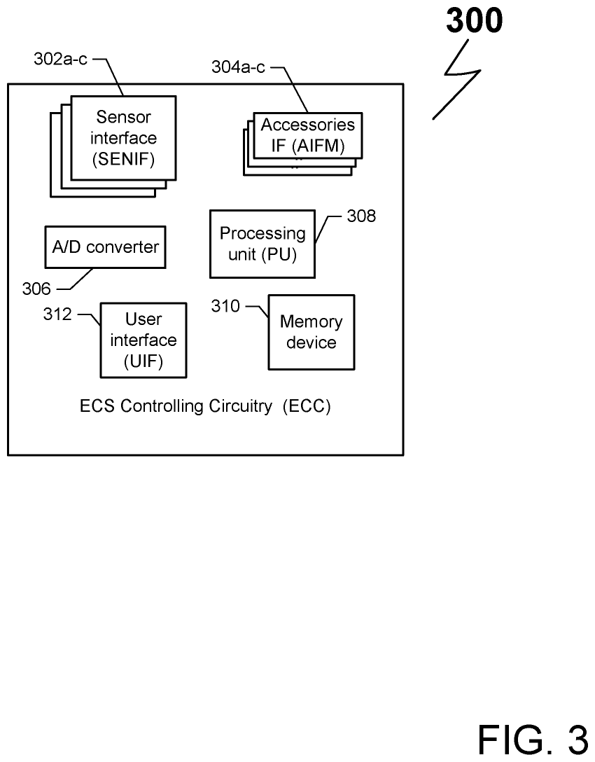

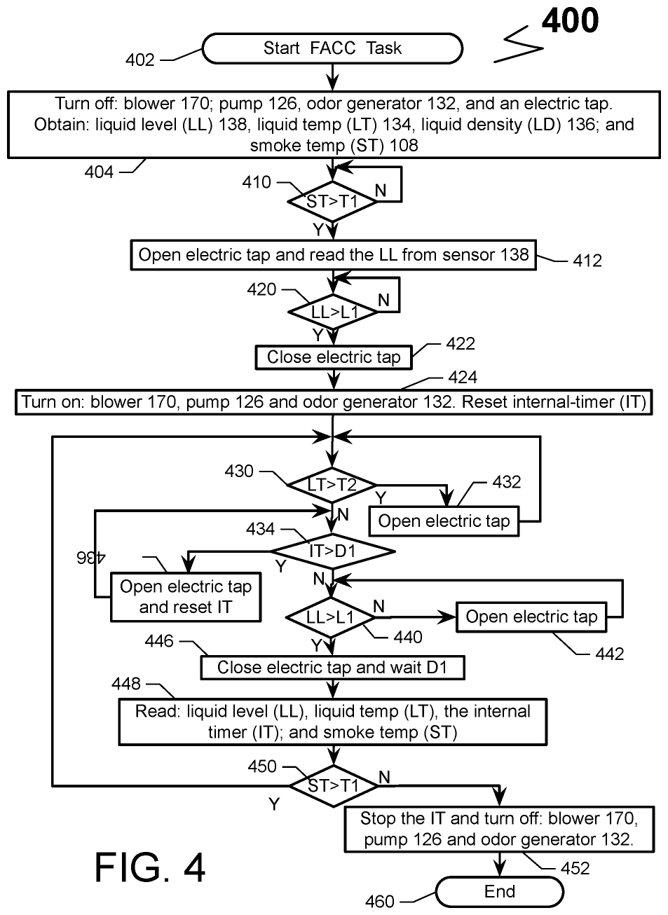

FIG. 1 shows a schematic presentation 100 of relevant elements of an example installation of Emission-Cleaning-System (ECS) 110 according to the present disclosure. ECS 110 can be controlled by a ECS Controlling-Circuitry (ECC) 105. In some example embodiment of the disclosed technique ECC 105 can be installed in ECS 110. In other examples embodiments outside of ECS 110 and can communicated with elements of ECS 110. More information about the operation of ECC 105 is disclosed below in conjunction with FIG. 3 and FIG. 4.

ECS 110 can be installed in association with chimney 104, on a roof of a house, for example. Emission from a common wood burning fireplace (WBF) 102 may move upward, freely, along chimney 104. A connecting-pipe 106 associates chimney 104 with an inlet connection 112 of a CSWLI 140 that is embedded in an ECS 110. Connecting-pipe 106 does not penetrate into chimney 104. Thus, the path via the chimney 104 remains clean without any disturbance to avoid backpressure. The smoke that is travel along chimney 104 is pulled by blower 160 toward the CSWLI 140 via connecting-pipe 106.

In some embodiments connecting-pipe 106 may have a shape of “T” that is associated with the chimney 104 in a location along the chimney. The smoke coming from the fireplace 102 via the chimney 104 may enter to a 1^{st} pipe of the “T” and may pass without any disturbance via a 2^{nd} pipe of the “T” toward the opening of the chimney. The 3^{rd} pipe of the “T” can be associated with the inlet 112 of the CSWLI 140. Thus, when the ECS 110 is not working the smoke moves upward, undisturbed, via the chimney 104 and when the ECS 110 is operating blower 160 pull the smoke toward the CSWLI 140 via inlet 112.

A temperature sensor 108 can be associated with chimney 104. The task of sensor 108 is to activate or deactivate ECS 110 based on the temperature of the chimney 104. In other example embodiments of the disclosed technique a user may activate ECS 110 after setting on fire in the WBF 102. ECS 110 can have a shape of cylinder wherein the diameter ‘D’ can be in the range of 25 cm to 60 cm. A Common diameter can be 30 cm. The height ‘H’ of ECS 110 can be in the range of 80 cm to 120 cm. A common height can be 100 cm.

An example of ECS 110 may comprise a tank 120 that includes liquid and may be associated with an odor generator 132. The liquid can be water, a combination of water and odor-liquid (OdL), etc. . . . The OdL may provide odor to the process of cleaning the smoke coming from the fireplace 102. The odor can be a neutral odor such as odor of a lemon, for example.

Tank 120 can be associated with one or more sensors. Sensors such as but not limited to temperature sensors 134, an optical sensor 136 and float 138 that sense the volume of the liquid in the tank or an ultrasonic sensor (not shown in the figures) that measure the distance between the sensor and the surface of the liquid in the tank.

Tank 120 can be associated with few pipes and a pump 126. A first pipe 122 may deliver clean liquid via an electric tap (not shown in the figures). The opening of this pipe can be placed deep in the tank 120. A second pipe 124 is used to drain surplus of the liquid out of tank 120 toward the sewage or to a treatment facility/system.

Pump 126 can be used to pull liquid from the bottom of the tank 120 and push it up via a 3^{rd} pipe 127 toward the connecting-pipe 106 that carries the smoke from chimney 104. The liquid that is pushed up via pipe 127 is injected into the smoke and air coming from the fireplace to generate a spray of drops of mixture of liquid and smoke/air as an input to the CSWLI 140. The processed-air at the outlet 142 of the CSWLI 140 is pulled up by blower 160 via a drops-capture module 150.

The drops-capture-module 150 removes drops of the liquid that remained in the processed-air and the cleaned air is exhausted out via outlet 170 to the environment. In some example embodiments of the disclosed technique outlet 170 may comprise a second drops-capture-module with ot without noise decreasing module. Liquid from the drops-capture-module 150 can return to tank 120 via the 4^{th} pipe 128.

CSWLI 140 can be associated with a hollow truncated cone 144 wherein the small base of cone 144 is associated with a first end of pipe 143 while the other end of pipe 143 is sunk deep in the liquid of tank 120. The truncated cone 144 and pipe 143 are used to transfer the liquid with the particles toward tank 120.

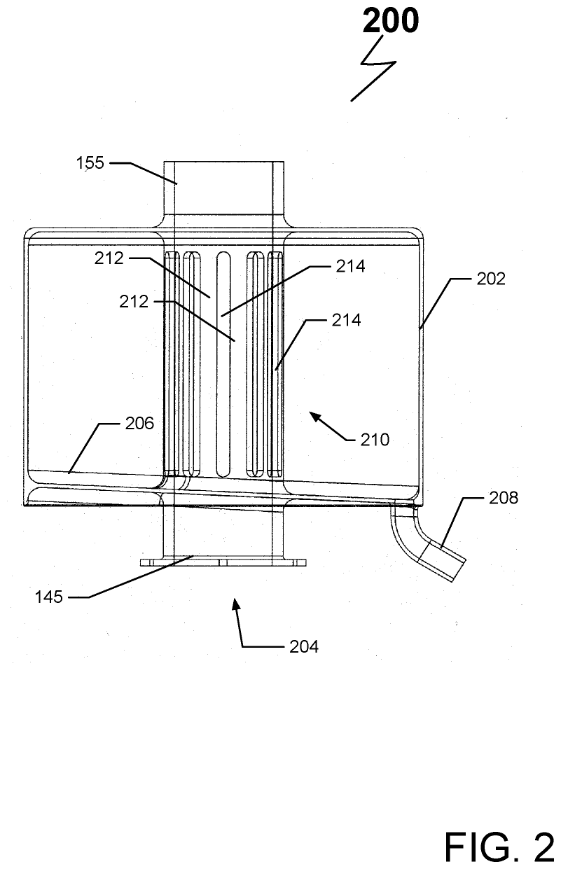

FIG. 2 illustrates a schematic presentation of relevant elements of an example of a drops-capture module 200 according to the present disclosure. Drops-capture module 200 may comprise an inlet 145, an outlet 155, a body 202 of the drops-capture module 200, a cyclone-droop separator (CDS) 210, a bottom 206 of the drops-capture module 200, and a liquid outlet 208. Bottom 206 has a slop that is configured to enable the collected drops to flow toward the outlet 208.

Processed-air 204 from the outlet 142 (FIG. 1) of the CSWLI 140 (FIG. 1) is pulled up by a blower 160 (FIG. 1), while it is spinning, and enters via inlet 145 to the central pipe of the Drops-capture module 200. The central pipe act as the CDS 210. The CDS 210 may comprise a plurality of vans 212 and a plurality of passages 214. The spinning processed air 204 coming from the CSWLI 140 caries drops of liquid. Due to the centrifugal force the drops of the liquid are thrown via passages 214 and be collected on bottom 206. The collected drops can flow toward outlet 208. In some example embodiments of the disclosed technique outlet 208 is connected via 4^{th} pipe 128 to tank 120 (FIG. 1).

The processed air, free of drops, is pulled out via outlet 155 from the drops-capture module 200 by blower 160 (FIG. 1) and be exhausted out to the environment via outlet 170 (FIG. 1).

Referring now to FIG. 3 that illustrates a simplified block diagram 300 with relevant elements of an example of a ECS-Controlling-Circuitry (ECC) 300 that operates according to an example of the disclosed technique. An example of ECC 300 may comprise one or more sensor-interface module (SIFM) 302a-c, one or more accessories-interface module (AIFM) 304a-c an analog to digital convertor (A/D) 306, a processing unit (PU) 308, a user interface (UIF) 312 and a memory device 310. Memory device 310 can be a non-transitory computer readable storage device such as a CDROM, a Flash memory, a ROM, a random access memory (RAM), etc.

Memory device 310 may store software code of one or more modules of ECC 300. In order to execute a certain task a software program may be loaded from memory device 310 to a processor of an appropriate module. Thus, each module 302a-c, 304a-c, PU 308, and UIF 312 can be a processor, which has been loaded with an appropriate software program, for example. In some embodiments the PU 308 can be a micro-controller or controlling circuitry that is configure to control the operation of ECC 300.

SIFM 302a-c can be an electronic circuitry that may be configured obtain an analog electronic signal from one of the sensors (134, 136, 138, and 108 FIG. 1), to amplify it to an appropriate level and to transfer the processed signal to the A/D converter 306. The A/D converter 306 converts the processed analog signal to digital to be stored in memory device 310 and be processed by PU 308. Some example of the sensors may deliver a digital signal in such a case the A/D converter is not used.

Example embodiment of AIFM 304a-c can be an electronic circuitry that may be configured convert a digital command received from the PU 308 to an analog electronic signal that activate one of the accessory. Accessory such as but not limited to blower 170, pump 126 and odor generator 132 (FIG. 1).

User interface 312 is configured to obtain instructions from a user and to deliver status information to the user. The instructions can be such as but not limited to loading software programs to memory device 310. Loading parameters of the ECS to the memory device, etc. More information on the operation of ECC 300 is disclosed below in conjunction with FIG. 4.

FIG. 4 schematically illustrates a flowchart 400 showing relevant processes that can be implemented by an example of PU 308 of ECC 300 (FIG. 3). An example embodiment of method 400 can be implemented in order to reduce of air pollutants from wood burning fireplace emissions. Process 400 can be initiated 402 upon setting a fire in fireplace 102 (FIG. 1). It can be initiated automatically or manually. Next, process 400 may turn off 404 via an appropriate AIFM 304a-c (FIG. 3) blower 170, pump 126, odor generator 132, and an electronic tap (not shown in the figures) that is associated with pipe 122 (FIG. 1).

Then, PU 308 may obtain 404 the readings of sensors 134 (the temperature of the tank 120), 136 (an optical sensor for determining the amount of particles in the tank), 138 (for determining the volume of the liquid in the tank) and 108 (for measuring the temperature of the chimney 104 (FIG. 1) via the appropriate SENIF 302a-c (FIG. 3) and A/D converter 306. Some example embodiment of the disclosed technique may use a timer instead of optical sensor 136.

At block 410 the temperature of the smoke (ST) can be read from sensor 108 (FIG. 1) and a decision is made 410 whether ST is higher than a threshold T1. T1 can be in the range of 40-80 degrees Celsius, for example. A common value of T1 can be 50 degrees Celsius, for example. If 410 ST is higher than T1, then the process continues to block 412. If ST is not higher than T1, then process 400 may wait 410 until the value of ST is higher than T1. In some example embodiments of the disclosed technique, block 410 can be modified to include additional threshold T3, which is higher than T1. In such embodiment, when ST is higher than T3, then PU 308 can be configured to increase the speed of blower 160 (FIG. 1).

Next at block 412 a command to open the electronic tap can be given by PU 308 via the relevant AIFM 304a-c and PU may sample the liquid level (LL) via the relevant SENIF 302a-c (FIG. 3) in the tank 120 (FIG. 1). Upon determining 420 that the LL is above the value L1, then an instruction to close 422 the electronic tap can be given. L1 can be in a level between the height of the opening of pipe 122 and the opening of pipe 124.

At block 424 PU 308 may reset an internal timer (IT) and may instruct the relevant AIFM 304a-c to turn on blower 170; pump 126, and odor generator 132 and process 400 may run in several loops. During the first loop (processes 430 and 432) the liquid temperature (LT) is measured by reading sensor 134 via it's SENIF 302a-c (FIG. 3). At block 430 the LT is compared to the value of a parameter T2 and if LT is higher that T2, then a command is given via the appropriate AIFM 304a-c (FIG. 3) to open the electric tap and deliver fresh and cold liquid via pipe 122 (FIG. 1) to tank 120 and process 400 returns to block 430. The value of T2 can be in the range of 50-90 degrees Celsius, for example. A common value of T2 can 65 degrees Celsius, for example.

If LT is not higher that T2, then process 400 may continue to block 434 and starts the second loop (434, 436). At block 434 the value of IT can be checked and a decision is made 434 whether the value of the internal timer (IT) is higher than D1. The value of D1 can be in the range of 5 to 10 minutes, 7 minutes, for example. If 434 IT is greater than D, then an instruction can be given 436 via the appropriate AIFM 304a-c to open the electric tap, the IT can be reset 436 and process 400 may return to block 434.

If 434 IT is no greater than D1, then at block 440 the liquid level (LL) in the tank 120 is compared to a parameter L1 and a decision is made 440 whether LL is greater than L1. The value of L1 can be between 60-80% of the height of the pipe 124, which is used to drain surplus of the liquid out of tank 120 (FIG. 1). If LL is not 440 greater than L1, then an instruction can be given 442 via the appropriate AIFM 304a-c to open the electric tap, and process 400 returns to block 440.

If 440 LL is greater than L1, then an instruction can be given 446 via the appropriate AIFM 304a-c to close the electric tap, and process 400 continues to block 448. At block 448 PU 308 may obtain the value of the IT, the readings of sensors 134 (the temperature of the tank 120), 138 (for determining the volume of the liquid in the tank) and 108 (for measuring the temperature of the chimney 104 (FIG. 1) via the appropriate SENIF 302a-c (FIG. 3) and A/D converter 306. Next a decision is made 450 whether the ST is higher than T1, which means that the fireplace is still active. If 450 ST is higher than T1, then process 400 may return to block 430.

If 450 ST is not higher than T1, then at block 452 may stop the IT and may instruct the relevant AIFM 304a-c to turn off blower 170; pump 126, and odor generator 132 and process 400 may be terminated 460. Some example embodiment of the disclosed technique a manual switch can be used in order to turn on and off the system. Thus, the switch can bypass process 410 for turning on the system. In addition, the switch can bypass process 450 for turning off the system.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to a problem, or any element that may cause any particular benefit, advantage, or solution to occur or to become more pronounced are not to be construed as critical, required, or essential features or components of any or all the claims.

As used herein, the terms “comprise,” “comprises,” “comprising,” “having,” “including,” “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition, or apparatus.

Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

1. An Emission-Cleaning-System (ECS) for reducing air pollution coming via a chimney, comprising:
a cyclone-separator-with-liquid-injectors (CSWLI) that is associated with the chimney, wherein the path via the chimney remains undisturbed;
a blower that is configured to pull smoke coming via the chimney toward the CSWLI;
and
an ECS Controlling Circuitry (ECC) that is configure to control the operation of the ECS.

2. The ECS of claim 1, further comprising a mechanism that is configured to deliver spray of drops of liquid toward the smoke before entering to the CSWLI.

3. The ECS of claim 1, wherein the chimney is a chimney of a fireplace.

4. The ECS of claim 2, wherein the mechanism that is configured to deliver the spray of drops of liquid, further comprising:
i. a tank that comprises the liquid;
ii. a first pipe that is configured to deliver clean liquid;
iii. a second pipe that is configured to drain surplus of the liquid out of the tank;
iv. a pump that is configured to pull the liquid from the tank and push it via a 3^{rd} pipe toward the smoke and generate the spray of drops of mixture of liquid and smoke as an input to the CSWLI; and
v. a 4^{th} pipe that is configured to return the liquid after being used in the CSWLI to the tank.

5. The ECS of claim 1, further comprising a drops-capture-module that is located between the CSWLI and the blower and is configured to remove drops of the liquid that were remained after being processed by the CSWLI.

6. The ECS of claim 1, wherein the ECC is associated with one or more sensors.

7. The ECS of claim 1, wherein the ECC is associated with one or more accessories.

8. The ECS of claim 1, wherein the ECC comprises:
i. a processing unit (PU); and
ii. a non-transitory computer readable storage device.

9. The ECS of claim 6, wherein at least one sensor, from the one or more sensors, is configured to sense the temperature of the smoke.

10. The ECS of claim 7, wherein at least one accessory, from the one or more accessories, is the pump.

11. The ECS of claim 8, wherein the non-transitory computer readable storage device is a random access memory (RAM).

12. The ECS of claim 8, wherein the non-transitory computer readable storage device stores software code to be executed by the processing unit.
